(19) United States
(12) Patent Application Publication
(10) Pub. No.: US 2025/0274776 A1
(43) Pub. Date: Aug. 28, 2025

(54) INTELLIGENT NETWORKING METHOD FOR A WI-FI MESH NETWORK, ELECTRONIC DEVICE AND COMPUTER-READABLE STORAGE MEDIUM

(71) Applicant: Nanning FuLian FuGui Precision Industrial Co., Ltd., Nanning (CN)

(72) Inventors: Dao-Pei Feng, Nanning (CN); Zhi-Qiang Wang, Shenzhen (CN); Zhan Huang, Nanning (CN)

(21) Appl. No.: 18/631,929

(22) Filed: Apr. 10, 2024

(30) Foreign Application Priority Data
Feb. 26, 2024 (CN) 202410211097.4

(51) Int. Cl. H04W 16/18; H04W 24/02; H04W 84/18

(52) U.S. Cl. CPC H04W 16/18; H04W 24/02; H04W 84/18

(57) ABSTRACT

An intelligent networking method for a Wi-Fi mesh network is disclosed. When a wireless mesh network, for example, a Wi-Fi mesh network, is built, communication indicators are converted into signal strength, and the signal strength is used to calculate a fitness function of performance indicators of the Wi-Fi mesh network. Based on the customized fitness function, artificial intelligence (AI) is used to calculate an optimal networking method for the Wi-Fi mesh network.

### FIELD

The disclosure relates to quality management, and more particularly to an intelligent networking method for a Wi-Fi mesh network, an electronic device and a computer-readable storage medium.

### BACKGROUND

With the development of digital network, the demand for a wireless mesh network, for example, a Wi-Fi mesh, network, construction is growing day by day, and construction of a wireless mesh network with excellent performance has become a very important issue.

### BRIEF DESCRIPTION OF THE DRAWINGS

Many aspects of the present disclosure can be better understood with reference to the following figures. The components in the figures are not necessarily drawn to scale, the emphasis instead being placed upon clearly illustrating the principles of the present disclosure. Moreover, in the drawings, like reference numerals designate corresponding parts throughout the several views. Implementations of the present technology will now be described, by way of embodiments, with reference to the attached figures, wherein:

FIG. 1 is a flowchart of an embodiment of an intelligent networking method for a Wi-Fi mesh network of the present disclosure;

FIG. 2 is schematic diagram of an embodiment of an application of the intelligent networking method for the Wi-Fi mesh network of the present disclosure;

FIG. 3 is schematic diagram of an embodiment of randomly generating device locations of the present disclosure;

FIG. 4 is schematic diagram of an embodiment of fitness function modeling of the present disclosure;

FIGS. 5A and 5B are schematic diagrams of an embodiment of estimation of Received Signal Strength Indication (RSSI) signal strength data between devices without obstacles of the present disclosure;

FIG. 6 is schematic diagram of an embodiment of an application of the relationship between the RSSI signal strength data and transmission rates of the present disclosure;

FIG. 7 is schematic diagram of an embodiment of obstacle factor determination of the present disclosure;

FIG. 8 is schematic diagram of an embodiment of equipment quantity determination of the present disclosure;

FIG. 9 is a block diagram of an embodiment of the hardware architecture of an electronic device using the method of the present disclosure; and

FIG. 10 is a block diagram of an embodiment of functional blocks of an electronic device of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

An intelligent networking method for a wireless mesh network, for example, a Wi-Fi mesh network, of the present invention converts, when building the Wi-Fi Mesh network, communication indicators into signal strength data and calculates a fitness function of performance indicators of the Wi-Fi Mesh network according to the signal strength data. The performance indicators include Received Signal Strength Indication (RSSI), obstacle factors between devices such as wireless access points (APs), a number of APs, AP radiation coverages, and so on. Based on the customized fitness function, an artificial intelligence (AI) algorithm, for example, a random reset hill-climbing algorithm, is used to calculate an optimal networking way for a Wi-Fi mesh network.

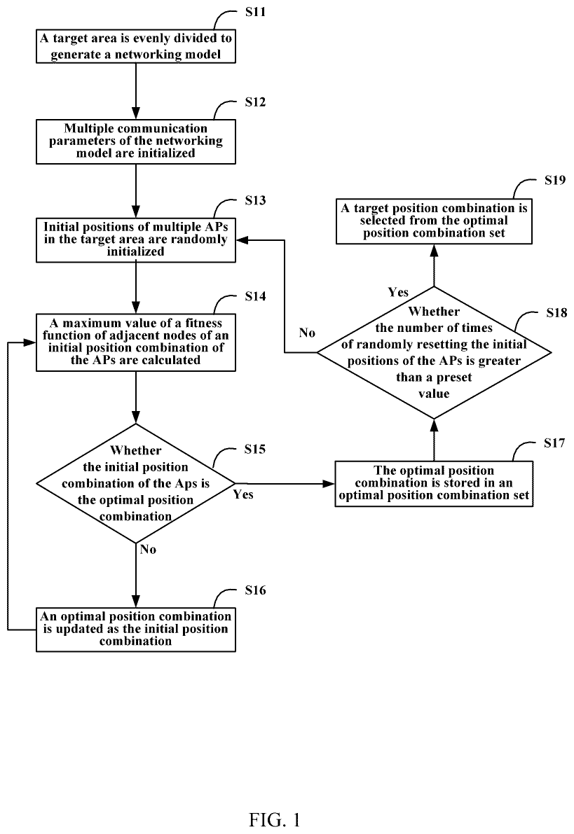

FIG. 1 is a flowchart of an embodiment of an intelligent networking method for a Wi-Fi mesh network of the present disclosure. According to different needs, the order of the steps in the flowchart can be changed, and some steps can be omitted.

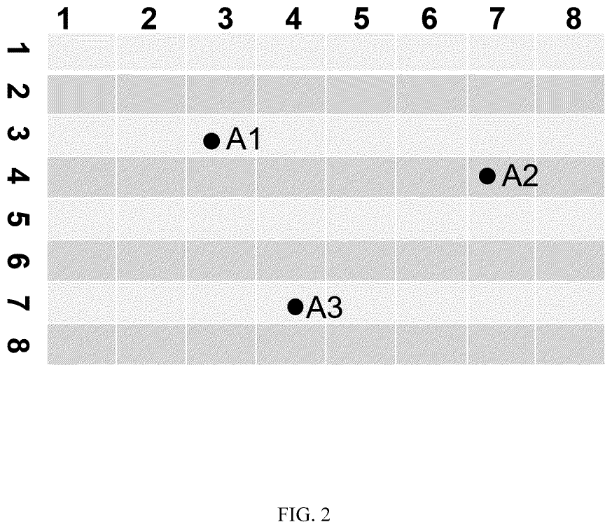

In step S11, a target area, for example, a large intelligent storage warehouse, is evenly divided into multiple sub-areas to generate a networking model. As shown in FIG. 2, the target area can be divided into 8*8=64 locations. Maximum values of the fitness functions of each device, for example, an access points (Aps), are calculated to obtain positions, for example, A1, A2, and A3, of corresponding APs while networking.

In step S12, multiple communication parameters of the networking model are initialized. The performance parameters include RSSI, obstacle factors between APs, a number of APs, AP radiation coverages, and so on.

In step S13, initial positions of multiple APs in the target area are randomly initialized.

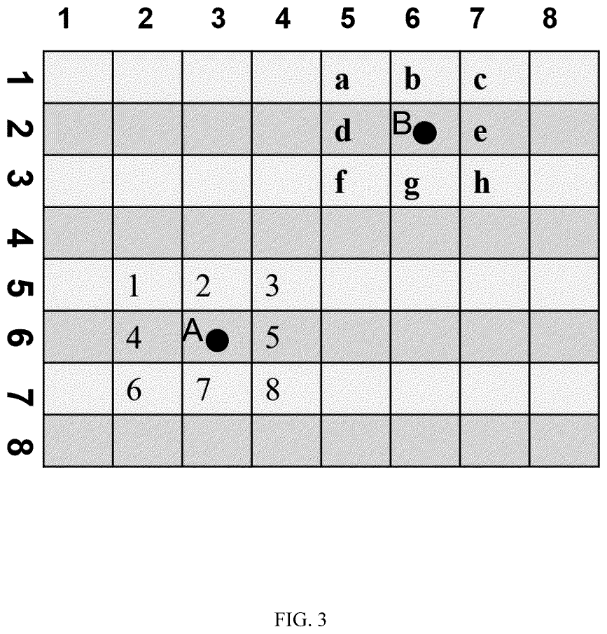

Referring to FIG. 3, adjacent nodes of AP A are 1-8, and adjacent nodes of AP B are a-h. When a random reset occurs, one or more positions of the APs are randomly generated among 64 positions.

In step S14, a maximum value of a fitness function of adjacent nodes of an initial position combination of the APs are calculated according to the communication parameters to obtain multiple position combinations of the APs in the target area.

The formula for calculating the fitness function F is represented as follows:

$$F = \{ ( {R}_{xy} \times {I}_{{R}_{xy}} + ( {R}_{xy} - {O}_{XY} ) / N ) \times {I}_{N} - {O}_{XY} \times {I}_{{O}_{XY}} \} \times Y ( C / A ) .$$

R_{xy} indicates that the RSSI signal strength of AP A_{y} is measured at AP Aₓ without obstacles, N indicates the number of APs, O_{XY} indicates the obstacle factors between AP A_{y} and AP Aₓ, A indicates the area of a building, C indicates an area of the building covered by AP radiations. I_{R}_{_{xy}} is the weight of R_{xy}, I_{N} is the weight of N and I_{O}_{_{XY}} is the weight of O_{XY}. In this embodiment, priority is given to the received signal strength R_{xy} when there are no obstacles, followed by the obstacle factor O_{XY}, and finally the number of APs N. Thus, the weight of R_{xy} is set to 45%, the weight of O_{XY} is set to 35%, and the weight of N is set to 20%. In other embodiments, the weight of R_{xy}, the weight of O_{XY}, and the weight of N can be set according to actual application situation requirements.

The obstacle factors include concrete walls, hollow brick walls, glass doors, wooden doors, etc. In actual calculations, the obstacle factors are substituted into calculations based on actual material types and the number of layers of penetrated materials.

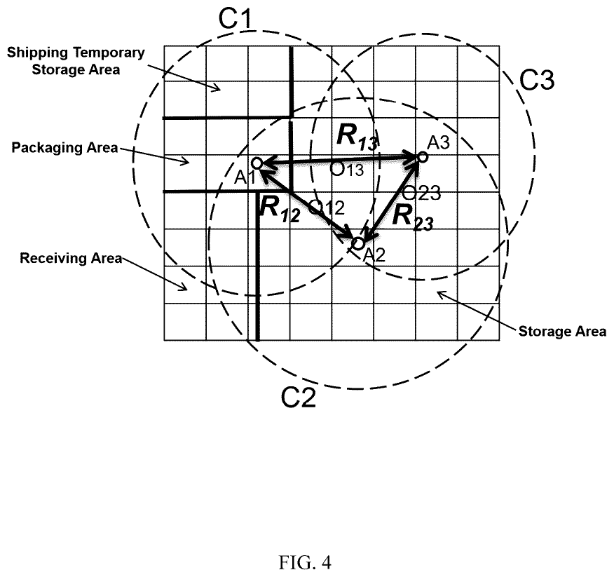

As shown in FIG. 4, the calculation of the fitness function is represented as

$$F = \{ ( ( {R}_{12} + {R}_{13} + {R}_{23} … + {R}_{( N - 1 ) N} ) \times 45 \% + ( ( {R}_{12} + {R}_{13} + {R}_{23} … + {R}_{( N - 1 ) N} ) - ( {O}_{12} + {O}_{13} + {O}_{23} … + {O}_{( N - 1 ) N} ) ) / N ) \times 20 \% - ( {O}_{12} + {O}_{13} + {O}_{23} … + {O}_{( N - 1 ) N} ) \times 35 \% \} \times ( C / A ) .$$

When there are no obstacles, the RSSI signal strength calculation formula between APs is represented as follows:

RSSI=−1.5×−30D (dBm), where D indicates a communication distance between APs.

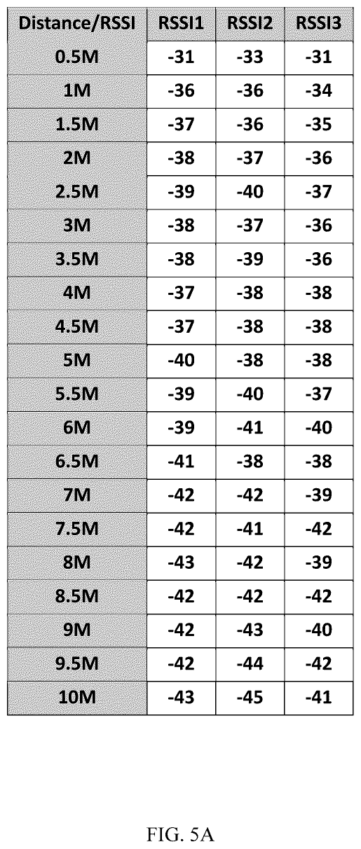

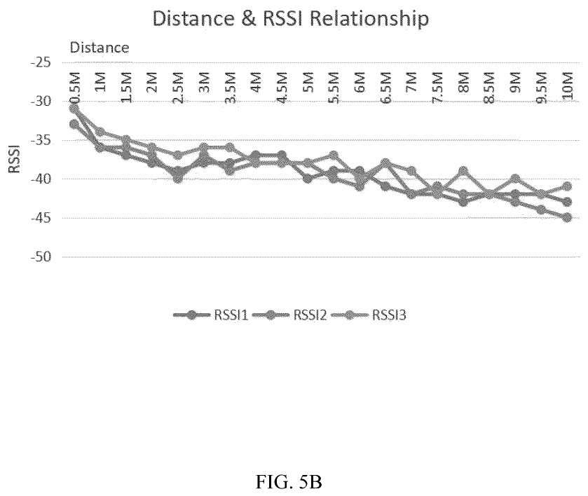

As shown in FIGS. 5A and 5B, for example, relationships between the distances between the three APs and RSSI, including RSSI1, RSSI2 and RSSI3, are represented according to calculation results.

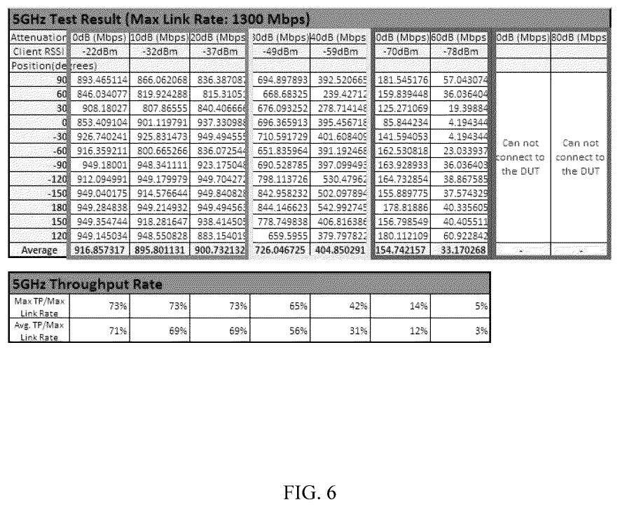

Referring to FIG. 6, as there are no obstacles and attenuation is adjusted, an average throughput of the block at first from the left (0 dB, 10 dB, 20 dB) is measured to be 904 Mbps, an average throughput of the block at second from the left (30 dB, 40 dB) is measured to be 565 Mbps, an average throughput of the block at second from the right (0 dB, 60 dB) is measured to be 94 Mbps, and an average throughput of the block at second from the right (0 dB, 80 dB) is measured to be 0 Mbps.

It can be seen from the data that when the RSSI is around −50 dBm, the transmission throughput is qualitatively decreased. In order to obtain a stable transmission rate, when the number of APs N in the fitness function is selected, try to ensure that the RSSI between the two APs is >−50 dBm.

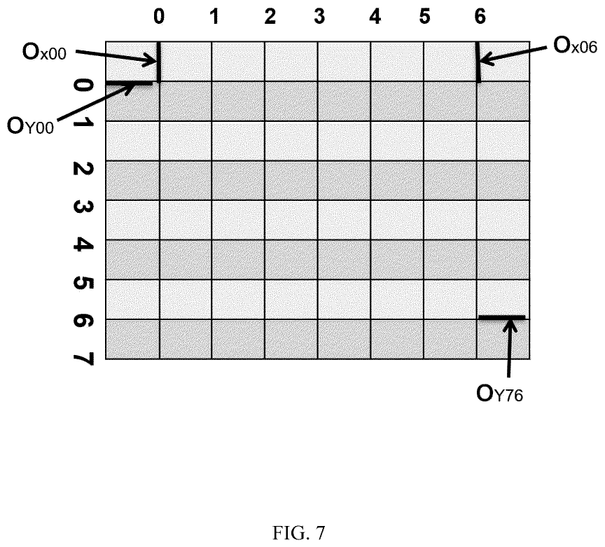

Regarding the obstacle factors, referring to FIG. 7, walls and doors in a real world are fitted to their nearest grid edges under a scene mode. Arrays in the X and Y directions are created respectively to store parameters of the obstacle factors of each grid. An attenuation parameter corresponding to an actual object is filled in a position where the actual object is located, and “0” is filled in a position where there is no actual object. Arrays established according to FIG. 7 is shown as follows:

ArrayX_{O}_{_{obstacle}}_{[8][7]}={{Oₓ,00,Oₓ01, . . . ,Oₓ06},{Oₓ,10,Oₓ,11, . . . ,Oₓ16}, . . . ,{Oₓ70,Oₓd,71, . . . ,Oₓ,76}}; and

ArrayY_{O}_{_{bstacle}}_{[8][7]}={{O_{Y}00,O_{Y}01, . . . ,O_{Y}06},{O_{Y}10,O_{Y}11, . . . ,O_{Y}16}, . . . ,{O_{Y}70,O_{Y}71, . . . ,O_{Y}76}}.

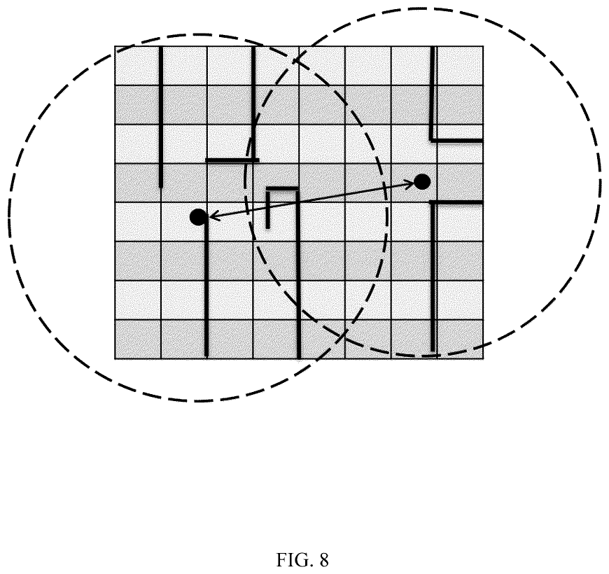

Referring to FIG. 8, a distance between each AP is less than 14 meters (M), and RSSI between two APs larger than −50 dBm is calculated using the following formula: RSSI=−1.5×−30D−K (dBm). A radiation coverage radius of an AP is considered as, for example, 14 meters (14M) to ensure that a desired paved area can be covered by radiating surfaces of all APs.

In step S15, it is determined whether the initial position combination of the APs in the target area is the optimal position combination among the position combinations.

In step S16, if the initial position combination of the APs is not the optimal position combination, an optimal position combination is updated as the initial position combination, and the process proceeds to step S14.

In step S17, if the initial position combination of the APs is the optimal position combination, the optimal position combination is stored in an optimal position combination set.

In step S18, it is determined whether the number of times of randomly resetting the initial positions of the APs in the target area is greater than a preset value, for example, 50, and, if not, the process proceeds to step S13.

In step S19, if the number of times of randomly resetting the initial positions of the APs in the target area is greater than the preset value, a target position combination is selected from the optimal position combination set, that is, the optimal position combination among the optimal position combinations.

It should be noted that the present invention uses a self-defined fitness functions and self-defined formulas to calculate the optimal networking combination of the Wi-Fi mesh network. The calculation process is a common technical means for those skilled in the art and will not be described in detail in this article.

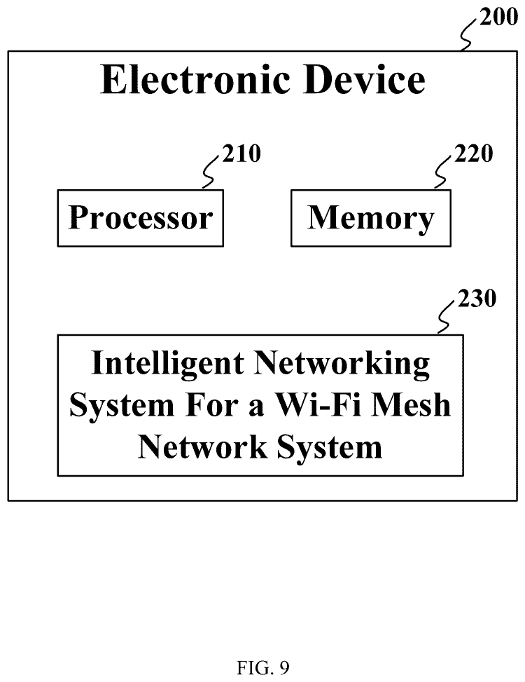

FIG. 9 is a block diagram of an embodiment of the hardware architecture of an electronic device using the intelligent networking method for a Wi-Fi mesh network of the present disclosure. The electronic device 200 may be, but is not limited to, connected to a processor 210, a memory 220, and an intelligent networking system for a Wi-Fi mesh network 230 via system buses. The electronic device 200 shown in FIG. 9 may include more or fewer components than those illustrated or may combine certain components.

The memory 220 stores a computer program, such as the intelligent networking system for a Wi-Fi mesh network 230, which is executable by the processor 210. When the processor 210 executes the intelligent networking system for a Wi-Fi mesh network 230, the blocks in one embodiment of the booting mode configuration method applied in the electronic device 200 are implemented, such as blocks S11 to S19 shown in FIG. 1.

It will be understood by those skilled in the art that FIG. 9 is merely an example of the electronic device 200 and does not constitute a limitation to the electronic device 200. The electronic device 200 may include more or fewer components than those illustrated or may combine certain components. The electronic device 200 may also include input and output devices, network access devices, buses, and the like.

The processor 210 may be a central processing unit (CPU), or other general-purpose processors, a digital signal processor (DSP), an application specific integrated circuit (ASIC), a Field-Programmable Gate Array (FPGA), or another programmable logic device, discrete gate or transistor logic device, discrete hardware components, or the like. The processor 210 may be a microprocessor or other processor known in the art.

The memory 220 can be used to store the intelligent networking system for a Wi-Fi mesh network 230 and/or modules/units by running or executing computer programs and/or modules/units stored in the memory 220. The memory 220 may include a storage program area and a storage data area. In addition, the memory 220 may include a high-speed random access memory, a non-volatile memory such as a hard disk, a plug-in hard disk, a smart memory card (SMC), and a secure digital (SD) card, flash card, at least one disk storage device, flash device, or another volatile solid state storage device.

The intelligent networking system for a Wi-Fi mesh network 230 can be partitioned into one or more modules/units that are stored in the memory 220 and executed by the processor 210. The one or more modules/units may be a series of computer program instructions capable of performing particular functions of the intelligent networking system for a Wi-Fi mesh network 230.

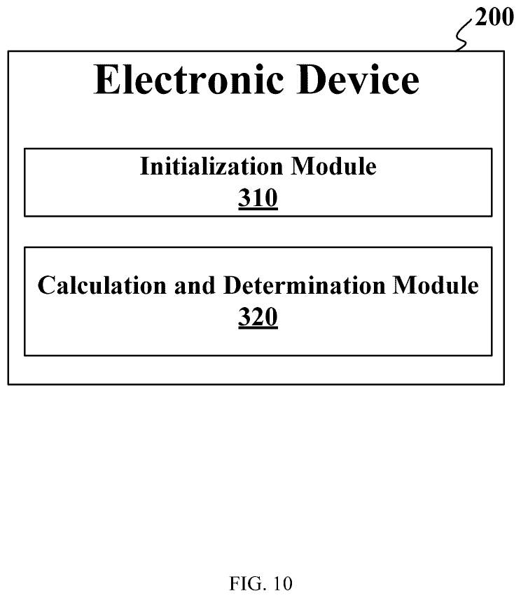

FIG. 10 is a schematic diagram of an embodiment of functional blocks of the electronic device using the method of the present disclosure.

The electronic device 200, for example, a smart networking server, comprises an initialization module 310 and a calculation and determination module 320.

The initialization module 310 evenly divides a target area, for example, a large intelligent storage warehouse, into multiple sub-areas to generate a networking model. As shown in FIG. 2, the target area can be divided into 8*8=64 locations. Maximum values of the fitness functions of each device, for example, an access points (Aps), are calculated to obtain positions, for example, A1, A2, and A3, of corresponding APs while networking.

The initialization module 310 initializes multiple communication parameters of the networking model. The performance parameters include RSSI, obstacle factors between APs, a number of APs, AP radiation coverages, and so on.

The initialization module 310 randomly initializes initial positions of multiple APs in the target area.

Referring to FIG. 3, adjacent nodes of AP A are 1-8, and adjacent nodes of AP B are a-h. When a random reset occurs, one or more positions of the APs are randomly generated among 64 positions.

The calculation and determination module 320 calculates maximum values of fitness functions of adjacent nodes of initial position combinations of the APs according to the communication parameters to obtain multiple position combinations of the APs in the target area.

The formula for calculating the fitness function F is represented as follows:

$$F = \{ ( {R}_{xy} \times {I}_{{R}_{xy}} + ( {R}_{xy} - {O}_{XY} ) / N ) \times {I}_{N} - {O}_{XY} \times {I}_{{O}_{XY}} \} \times ( C / A ) .$$

R_{xy} indicates that the RSSI signal strength of AP A_{y} is measured at AP Aₓ without obstacles, N indicates the number of APs, O_{XY} indicates the obstacle factors between AP A_{y} and AP Aₓ, A indicates the area of a building, C indicates an area of the building covered by AP radiations. I_{R}_{_{xy}} is the weight of R_{xy}, I_{N} is the weight of N and I_{O}_{_{XY}} is the weight of O_{XY}. In this embodiment, priority is given to the received signal strength R_{xy} when there are no obstacles, followed by the obstacle factor O_{XY}, and finally the number of APs N. Thus, the weight of R_{xy} is set to 45%, the weight of O_{XY} is set to 35%, and the weight of N is set to 20%. In other embodiments, the weight of R_{xy}, the weight of O_{XY}, and the weight of N can be set according to actual application situation requirements.

The obstacle factors include concrete walls, hollow brick walls, glass doors, wooden doors, etc. In actual calculations, the obstacle factors are substituted into calculations based on actual material types and the number of layers of penetrated materials.

The calculation and determination module 320 determines whether the initial position combination of the APs in the target area is the optimal position combination among the position combinations.

If the initial position combination of the APs is not the optimal position combination, the calculation and determination module 320 updates an optimal position combination as the initial position combination.

If the initial position combination of the APs is the optimal position combination, the calculation and determination module 320 stores the optimal position combination in an optimal position combination set.

The calculation and determination module 320 determines whether the number of times of randomly resetting the initial positions of the APs in the target area is greater than a preset value, for example, 50.

If the number of times of randomly resetting the initial positions of the APs in the target area is greater than the preset value, the calculation and determination module 320 selects a target position combination from the optimal position combination set, that is, the optimal position combination among the optimal position combinations.

It is to be understood, however, that even though numerous characteristics and advantages of the present disclosure have been set forth in the foregoing description, together with details of the structure and function of the present disclosure, the disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An intelligent networking method for a Wi-Fi mesh network executable by an electronic device, comprising:
evenly dividing a target area into multiple sub-areas to generate a networking model;
initializing multiple communication parameters of the networking model;
randomly initializing initial positions of multiple access points (APs) in the target area;
calculating a maximum value of a fitness functions of adjacent nodes of an initial position combination of the APs according to the communication parameters to obtain multiple position combinations of the APs in the target area;
determining whether the initial position combination of the APs in the target area is the optimal position combination among the position combinations;
if the initial position combination of the APs is the optimal position combination, storing the optimal position combination in an optimal position combination set;
determining whether the number of times of randomly resetting the initial positions of the APs in the target area is greater than a preset value; and
if the number of times of randomly resetting the initial positions of the APs in the target area is greater than the preset value, selecting a target position combination from the optimal position combination set.

2. The method of claim 1, wherein the formula for calculating the fitness function F is represented as follows:
$$F = \{ ( {R}_{xy} \times {I}_{{R}_{xy}} + ( {R}_{xy} - {O}_{XY} ) / N ) \times {I}_{N} - {O}_{XY} \times {I}_{{O}_{XY}} \} \times ( C / A ) ,$$
wherein R_{xy} indicates that the RSSI signal strength of AP A_{y} is measured at AP Aₓ without obstacles, N indicates the number of APs, O_{XY} indicates the obstacle factors between AP A_{y} and AP Aₓ, A indicates the area of a building, C indicates an area of the building covered by AP radiations. I_{R}_{_{xy}} is the weight of R_{xy}, I_{N} is the weight of N and I_{O}_{_{XY}} is the weight of O_{XY}.

3. The method of claim 1, further comprising:
updating an optimal position combination as the initial position combination if the initial position combination of the APs is not the optimal position combination.

4. The method of claim 1, wherein the RSSI signal strength calculation formula between APs is represented as follows:
RSSI=−1.5×−30D (dBm), wherein D indicates a communication distance between APs.

5. The method of claim 1, wherein the preset value is 50.

6. An electronic device, which includes a memory, a processor, and a serial number length adjustment program stored in the memory and operable on the processor, wherein the serial number length adjustment program is executed by the processor to implement following steps:
evenly dividing a target area into multiple sub-areas to generate a networking model;
initializing multiple communication parameters of the networking model;
randomly initializing initial positions of multiple access points (APs) in the target area;
calculating a maximum value of a fitness functions of adjacent nodes of an initial position combination of the APs according to the communication parameters to obtain multiple position combinations of the APs in the target area;
determining whether the initial position combination of the APs in the target area is the optimal position combination among the position combinations;
if the initial position combination of the APs is the optimal position combination, storing the optimal position combination in an optimal position combination set;
determining whether the number of times of randomly resetting the initial positions of the APs in the target area is greater than a preset value; and
if the number of times of randomly resetting the initial positions of the APs in the target area is greater than the preset value, selecting a target position combination from the optimal position combination set.

7. The device of claim 6, wherein the formula for calculating the fitness function F is represented as follows:
$$F = \{ ( {R}_{xy} \times {I}_{{R}_{xy}} + ( {R}_{xy} - {O}_{XY} ) / N ) \times {I}_{N} - {O}_{XY} \times {I}_{{O}_{XY}} \} \times ( C / A ) ,$$
wherein R_{xy} indicates that the RSSI signal strength of AP A_{y} is measured at AP Aₓ without obstacles, N indicates the number of APs, O_{XY} indicates the obstacle factors between AP A_{y} and AP Aₓ, A indicates the area of a building, C indicates an area of the building covered by AP radiations. I_{Rx}, is the weight of R_{xy}, I_{N} is the weight of N and I_{O}_{_{XY}} is the weight of O_{XY}.

8. The device of claim 6, wherein the serial number length adjustment program is executed by the processor to implement following steps:
updating an optimal position combination as the initial position combination if the initial position combination of the APs is not the optimal position combination.

9. The device of claim 6, wherein the RSSI signal strength calculation formula between APs is represented as follows:
RSSI=−1.5×−30D (dBm), wherein D indicates a communication distance between APs.

10. The device of claim 6, wherein the preset value is 50.

11. A non-transitory computer-readable storage medium storing game program which causes a computer to execute:
a process of
evenly dividing a target area into multiple sub-areas to generate a networking model;
initializing multiple communication parameters of the networking model;
randomly initializing initial positions of multiple access points (APs) in the target area;
calculating a maximum value of a fitness functions of adjacent nodes of an initial position combination of the APs according to the communication parameters to obtain multiple position combinations of the APs in the target area;
determining whether the initial position combination of the APs in the target area is the optimal position combination among the position combinations;
if the initial position combination of the APs is the optimal position combination, storing the optimal position combination in an optimal position combination set;
determining whether the number of times of randomly resetting the initial positions of the APs in the target area is greater than a preset value; and
if the number of times of randomly resetting the initial positions of the APs in the target area is greater than the preset value, selecting a target position combination from the optimal position combination set.

12. The non-transitory computer-readable storage medium of claim 11, wherein the formula for calculating the fitness function F is represented as follows:
$$F = \{ ( {R}_{xy} \times {I}_{{R}_{xy}} + ( {R}_{xy} - {O}_{XY} ) / N ) \times {I}_{N} - {O}_{XY} \times {I}_{{O}_{XY}} \} \times ( C / A ) ,$$
wherein R_{xy} indicates that the RSSI signal strength of AP A_{y} is measured at AP Aₓ without obstacles, N indicates the number of APs, O_{XY} indicates the obstacle factors between AP A_{y} and AP Aₓ, A indicates the area of a building, C indicates an area of the building covered by AP radiations. I_{R}_{_{xy}} is the weight of R_{xy}, I_{N} is the weight of N and I_{O}_{_{XY}} is the weight of O_{XY}.

13. The non-transitory computer-readable storage medium of claim 11, wherein the computer further executes:
updating an optimal position combination as the initial position combination if the initial position combination of the APs is not the optimal position combination.

14. The non-transitory computer-readable storage medium of claim 11, wherein the RSSI signal strength calculation formula between APs is represented as follows:
RSSI=−1.5×−30D (dBm), wherein D indicates a communication distance between APs.

15. The non-transitory computer-readable storage medium of claim 11, wherein the preset value is 50.
